(19) United States
(12) Patent Application Publication
(10) Pub. No.: US 2026/0036859 A1
(43) Pub. Date: Feb. 5, 2026

(54) ELECTROCHROMIC ELEMENT, METHOD FOR MANUFACTURING THE SAME, AND DEVICES INCLUDING THE ELECTROCHROMIC ELEMENT

(71) Applicant: CANON KABUSHIKI KAISHA, Tokyo (JP)

(72) Inventor: KAZUYA MIYAZAKI, Tokyo (JP)

(21) Appl. No.: 19/352,303

(22) Filed: Oct. 7, 2025

Related U.S. Application Data
(63) Continuation of application No. PCT/JP2024/014984, filed on Apr. 15, 2024.

(30) Foreign Application Priority Data
Apr. 25, 2023 (JP) 2023-071494

(51) Int. Cl. G02F 1/1514; G02F 1/155; G02F 1/157

(52) U.S. Cl. CPC G02F 1/1514; G02F 1/155; G02F 1/157; G02F 2001/15145

(57) ABSTRACT

The present disclosure provides an EC element in which a separator divides the gap between a pair of electrodes into two sections defining a pair of EC layers, each containing an EC compound. The separator has a smaller thermal expansion coefficient than the electrodes and is bonded to each of the electrodes with an acrylic adhesive. The acrylic adhesive enables the separator to be provided without wrinkles or sagging.

### CROSS-REFERENCE TO RELATED APPLICATIONS

This application is a Continuation of International Patent Application No. PCT/JP2024/014984, filed Apr. 15, 2024, which claims the benefit of Japanese Patent Application No. 2023-071494, filed Apr. 25, 2023, both of which are hereby incorporated by reference herein in their entirety.

### BACKGROUND

### Field of the Technology

The present disclosure relates to an electrochromic element, a method for manufacturing the same, and devices including the electrochromic element.

### Description of the Related Art

An electrochromic (hereinafter also abbreviated to EC) element includes a pair of electrodes and an EC layer between the electrodes. The EC element is an active optical element that adjusts the hue or amount of light in the visible light region by applying a voltage between the pair of electrodes to oxidize or reduce a compound in the EC layer.

The application of EC elements has gradually expanded as dimming windows for homes and aircraft, and in recent years, there has been growing demand for environmental considerations. Accordingly, a dimming window that achieves a larger area and lower power consumption while maintaining performance is demanded.

EC elements using organic EC compounds, first, have a wide range of adjustments in the amount of light and are relatively easy to design in color. In addition, it is preferable in view of the coloration efficiency (amount obtained by dividing change in optical density by required charge) to complementarily contain an electrochemically active anodic material and an electrochemically active cathodic material between the pair of electrodes, both of which have EC properties.

In order to achieve a rapid response, larger amounts of organic EC compounds are required to react per unit time at the surface of the electrodes. For this purpose, the EC layer is preferably in the form of a solution or gel, which allows organic EC compounds to move freely within the EC layer. In such a form, however, the anodic and cathodic organic EC compounds that have reacted between the pair of electrodes undergo charge exchange (side reaction) within the EC layer and relax their electrochemical behavior to neutral states. Therefore, continuous energization is required to maintain the optical density. This hinders the reduced power consumption of complementary EC elements.

U.S. Pat. No. 3,453,038 discloses a structure for complementary EC elements in which a permselective film that allows electrolyte ions to pass through but not the reaction molecules of the EC compounds is provided using a gasket to avoid side reaction between reaction products produced at the pair of electrodes.

Also, Japanese Patent Laid-Open No. 2018-177605 discloses a structure of multi-layered glass in which an intermediate film having a lower thermal expansion coefficient than a substrate (glass substrate) is joined to the substrate with a spacer member therebetween using an adhesive and a primary sealing agent.

The structure disclosed in U.S. Pat. No. 3,453,038 may limit the process for element fabrication when applied to EC elements because the permselective film is provided using a gasket. The structure disclosed in Japanese Patent Laid-Open No. 2018-177605 can be applied when the multi-layered glass has a gap of several millimeters between the substrate and the intermediate film, but cannot be applied to EC elements, in which the gap is as small as several tens of microns.

In an EC element with an EC layer divided into two sections by a separator, if the thermal expansion coefficient of the separator is smaller than that of the electrodes, the separator may wrinkle, sag, or separate from the electrodes through a heating step in the manufacturing process.

### SUMMARY

Accordingly, the present disclosure provides an EC element that is provided with a separator with a smaller thermal expansion coefficient than the substrate in the EC layer and has a structure enabling the separator to extend across the EC element without wrinkles or sagging.

An electrochromic element according to an aspect of the present disclosure includes a first electrode, a second electrode, a separator that divides a gap between the first electrode and the second electrode into two sections, a first electrochromic layer disposed between the first electrode and the separator and containing at least one electrochromic compound, and a second electrochromic layer disposed between the second electrode and the separator and containing at least one electrochromic compound. The separator has a smaller thermal expansion coefficient than the first and second electrodes. Each of the first electrode and the second electrode is bonded to the separator with an acrylic adhesive.

A method according to the present disclosure for manufacturing an electrochromic element includes bonding each of a first electrode and a second electrode to the separator with an acrylic adhesive, curing the acrylic adhesive, and then heat-treating the acrylic adhesive.

Features of the present disclosure will become apparent from the following description of embodiments with reference to the attached drawings.

### BRIEF DESCRIPTION OF THE DRAWINGS

FIG. 1 is a schematic sectional view of an EC element according to an embodiment of the present disclosure taken in the thickness direction.

FIG. 2A is a schematic sectional view of an EC element of the present disclosure taken in the thickness direction, illustrating an example of seal placement.

FIG. 2B is a schematic sectional view of an EC element of the present disclosure taken in the thickness direction, illustrating an example of seal placement.

FIG. 2C is a schematic sectional view of an EC element of the present disclosure taken in the thickness direction, illustrating an example of seal placement.

FIG. 3 is a schematic diagram of an example of the drive unit including an EC element according to an embodiment of the present disclosure.

FIG. 4A is a schematic diagram of an example of the imaging device in which an optical filter is disposed in a lens unit.

FIG. 4B is a schematic diagram of an example of the imaging device in which an optical filter is disposed in an imaging unit.

FIG. 5A is a schematic diagram of a window using an EC element according to an embodiment of the present disclosure.

FIG. 5B is a schematic sectional view of a window using an EC element according to an embodiment of the present invention, taken in the thickness direction.

### DESCRIPTION OF THE EMBODIMENTS

The electrochromic (EC) element of the present disclosure includes a pair of electrochromic layers separated by a separator that divides the gap between electrodes into two sections. In the EC element of the present, each of the pair of EC layers contains at least one electrochromic compound, and the separator and the electrodes are bonded with an acrylic adhesive so that the separator is disposed in the EC element without wrinkles or sagging, resulting in an EC element with high display quality.

Exemplary embodiments of the electrochromic element disclosed herein will be described in detail with reference to the drawings. The configuration, relative positions, and the like described in the following embodiments are not intended to limit the scope of the present disclosure unless otherwise described.

### EC Element

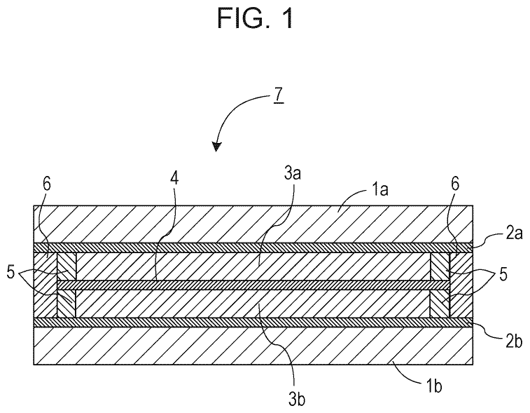

The configuration of the EC element disclosed herein will be described with reference to FIG. 1. FIG. 1 is a schematic sectional view of an EC element 7 according to an embodiment of the present disclosure. In FIG. 1, reference numerals 1a and 1b denote a pair of substrates. A pair of electrodes 2a and 2b are disposed on one surface, on the inner side of the element, of the substrates 1a and 1b, respectively. Reference numeral 4 denotes a separator, and reference numeral 5 denotes an adhesive that bonds the electrodes 2a and 2b on the respective substrates 1a and 1b to the separator 4. EC layers 3a and 3b are disposed respectively in a pair of spaces defined by the electrodes 2a and 2b, the separator 4, and the adhesive 5, and a seal 6 is provided at the periphery of the element so as to surround the EC layers. In the following description, the substrate 1a is referred to as the first substrate; the substrate 1b as the second substrate; the electrode 2a as the first electrode; the electrode 2b as the second electrode; the EC layer 3a as the first EC layer; and the EC layer 3b as the second EC layer, for convenience.

The members or components of the EC element according to the present disclosure will now be described in detail.

The pair of substrates 1a and 1b are made of an electrical insulator, such as glass or resin, and are required to be highly transparent, heat-resistant, and chemically stable. Examples of the glass include optical glass, quartz glass, white glass, soda-lime glass, borosilicate glass, non-alkali glass, and chemically reinforced glass. In particular, non-alkali glass is preferably used from the viewpoint of transparency and durability. Examples of the resin include polycarbonate (PC), polymethyl methacrylate (PMMA), polyethylene terephthalate (PET), and transparent polyimide (PI). Any of such resins, provided with a hard coating layer on their surface to enhance scratch resistance, can be preferred for use.

The pair of electrodes 2a and 2b are made of a transparent electrically conductive material, such as indium tin oxide (ITO), fluorine-doped tin oxide (FTO), tin oxide (NESA), indium zinc oxide (IZO), and graphene. Conductive polymers whose electrical conductivity is increased by doping or the like may also be used preferably, and examples include polyaniline, polypyrrole, polythiophene, polyacetylene, poly(para-phenylene), and complexes of polyethylenedioxythiophene (PEDOT) and poly(styrenesulfonic acid).

The pair of EC layers 3a and 3b are preferably in the form of a solution or gel containing an EC compound dissolved in an organic solvent and may also contain an electrolyte. Also, a spacer may be provided to fix distances between each of the electrodes 2a and 2b and the separator 4. The spacer may be an inorganic material, such as silica beads or glass fibers, or an organic material, such as polydivinylbenzene, polyimide, polytetrafluoroethylene, fluorocarbon rubber, or epoxy resin.

The EC layers 3a and 3b may be formed by introducing a liquid containing EC compounds prepared in advance into the gaps between the pair of electrodes 2a and 2b and the separator 4, using vacuum injection, atmospheric injection, a meniscus technique, or the like. Alternatively, the liquid containing EC compounds may be dropped by an ODF (One Drop Fill) method, followed by bonding the electrodes and the separator 4 together, or may be applied onto the pair of electrodes 2a and 2b by blade coating, bar coating, slit die coating, or the like, followed by bonding the electrodes and the separator 4 together.

The EC compounds are preferably organic compounds and may be anodic compounds that are changed from a transparent state to a colored state by an oxidation reaction or cathodic compounds that are changed from a transparent state to a colored state by a reduction reaction. Both an anodic compound and a cathodic compound may be used. Using an anodic compound and a cathodic compound together increases coloration efficiency for current. In the description presented herein, an element containing both an anodic compound and a cathodic compound is referred to as a complementary EC element. Anodic compounds may also be referred to as anodic materials, and cathodic compounds may also be referred to as cathodic materials.

When a complementary EC element operates, an oxidation reaction occurs at one electrode to draw electrons from the EC compound, and at the other electrode, a reduction reaction occurs to give electrons to the EC compound. The oxidation reaction may produce radical cations from neutral molecules. The reduction reaction may produce radical anions from neutral molecules or produce radical cations from dicationic molecules. When a large change in optical density is required, a complementary EC element, in which the EC compounds exhibit a color at the pair of electrodes 2a and 2b, is preferred.

Examples of organic EC compounds include electrically conductive polymers, such as polythiophene and polyaniline, and low-molecular-weight organic compounds, such as viologen-based compounds, anthraquinone-based compounds, oligothiophene derivatives, and phenazine derivatives.

In the present disclosure, the first EC layer 3a contains at least one anodic EC Compound, and the second EC layer 3b contains at least one cathodic EC Compound. Also, the separator 4 is preferably a permselective film that does not allow the EC compounds to pass through, but allows electrolytes. Such a structure prevents the contact between the cathodic EC compounds in excitation in the first EC layer 3a and the anodic EC compounds in excitation in the second EC layer 3b to inhibit their cross-reaction (side reaction). Consequently, the power consumption of the EC element 7 is reduced. In this instance, the materials of the EC layers 3a and 3b may have the same composition. The following is a specific description of a complementary EC element.

If the EC layers 3a and 3b contain a plurality of EC compounds, the difference in redox potential between the EC compounds is preferably small. Such EC layers containing a plurality of EC compounds may contain four or more EC compounds in combination of anodic and cathodic compounds. The EC element of the present disclosure may contain five or more EC compounds. When a plurality of EC compounds are contained, the redox potential of the plurality of anodic materials may be within 60 mV, and the redox potential of the plurality of cathodic materials may be within 60 mV. When a plurality of EC compounds are contained, the plurality of EC compounds may include a compound having an absorption peak at a wavelength of 400 nm to 500 nm, a compound having an absorption peak at a wavelength of 500 nm to 650 nm, and a compound having an absorption peak at a wavelength of 650 nm or more. An absorption peak is defined as a peak having a half width of 20 nm or more. When absorbing light, the materials may be in an oxidized state, a reduced state, or a neutral state.

The electrolyte is an ionically dissociable salt that exhibits high solubility in the solvent, or, in the case of a solid electrolyte, high compatibility with the solvent, and is not otherwise limited. Among such electrolytes, electron-donating electrolytes are preferred. These electrolytes can be referred to as supporting electrolytes. Examples of the electrolyte include inorganic salts, such as alkali metal salts and alkaline-earth metal salts, quaternary ammonium salts, and cyclic quaternary ammonium salts. More specifically, examples include alkali metal (Li, Na, or K) salts, such as LiClO₄, LiSCN, LiBF₄, LiAsF₆, LiCF₃SO₃, LiPF₆, LiI, NaI, NaSCN, NaClO₄, NaBF₄, NaAsF₆, KSCN, and KCl; and quaternary ammonium salts or cyclic quaternary ammonium salts, such as (CH₃)₄NBF₄, (C₂H₅)₄NBF₄, (n-C₄H₉)₄NBF₄, (n-C₄H₉)₄NPF₆, (C₂H₅)₄NBr, (C₂H₅)₄NClO₄, and (n-C₄H₉)₄NClO₄.

The solvent to dissolve the EC compound and electrolyte is not limited, provided that it can dissolve the EC compounds and electrolyte, but preferably, it is a polar solvent. Specifically, examples of the solvent include water and organic polar solvents, such as methanol, ethanol, propylene carbonate, ethylene carbonate, dimethyl sulfoxide, dimethoxyethane, γ-butyrolactone, γ-valerolactone, sulfolane, dimethylformamide, tetrahydrofuran, acetonitrile, propionitrile, 3-methoxypropionitrile, benzonitrile, dimethylacetamide, methylpyrrolidinone, and dioxolane.

The EC layers 3a and 3b may further contain a polymer matrix, a gelling agent, and a crosslinking agent. In this instance, the EC layers 3a and 3b may be changed into a gel (physical gel) from a highly viscous liquid by adding a polymer alone or gelled (into a chemical gel) by further adding a crosslinking agent to the polymer matrix. Examples of the polymer matrix include polyacrylonitrile, carboxymethyl cellulose, pullulan-based polymer, polyvinyl chloride, polyethylene oxide, polypropylene oxide, polyurethane, polyacrylate, polymethacrylate, polyamide, polyacrylamide, polyester, poly(vinylpyridine), and Nafion (registered trademark).

When the separator 4 is a permselective film that does not allow the EC compounds to pass through, but allows electrolytes, the separator 4 is preferably made of nanofibers. Nanocellulose (cellulose nanofibers, hereinafter also abbreviated to “CNF”), particularly with a fiber diameter of 10 nm or less, is preferably used to ensure transparency to visible light.

The separator 4 made of nanofibers has a thermal expansion coefficient of about 0.1×10⁻⁶ K⁻¹, which is one to two orders of magnitude smaller than the thermal expansion coefficient of ITO, the material generally used in the electrodes 2a and 2b. Also, the thermal expansion coefficient of glass or PET films, which are used as the substrates 1a and 1b, on which the electrodes 2a and 2b are formed, is one to two orders of magnitude larger than that of the separator 4. Consequently, the differences in thermal expansion coefficient can cause the separator 4 to sag, wrinkle, or separate from the electrodes 2a and 2b in the fabricated EC element, unless an appropriate adhesion method is used.

The adhesive 5 is intended to connect the separator 4 to the pair of electrodes 2a and 2b and functions to extend the separator 4, which is a thin film of several tens of micrometers, without wrinkles or sagging, and to maintain the gaps constant. Also, since the adhesive 5 directly contacts the electrochemically active EC layers 3a and 3b, it is required to have no reactivity with the EC compounds and low affinity with the solvent dissolving the EC compounds. Accordingly, acrylic adhesive, which has good adhesion to the electrodes and a nature facilitating relaxation of internal stresses, is used as the adhesive 5. Preferably, the adhesive is a UV-curable acrylic adhesive, particularly a one-component, solvent-free acrylic adhesive. The UV-curable acrylic adhesive is preferably heat-treated after being cured by UV irradiation.

The seal 6 is preferably made of a chemically stable material that is impermeable to gases and liquids. For example, the seal 6 may be made of an inorganic material such as glass frit or an organic material such as epoxy resin.

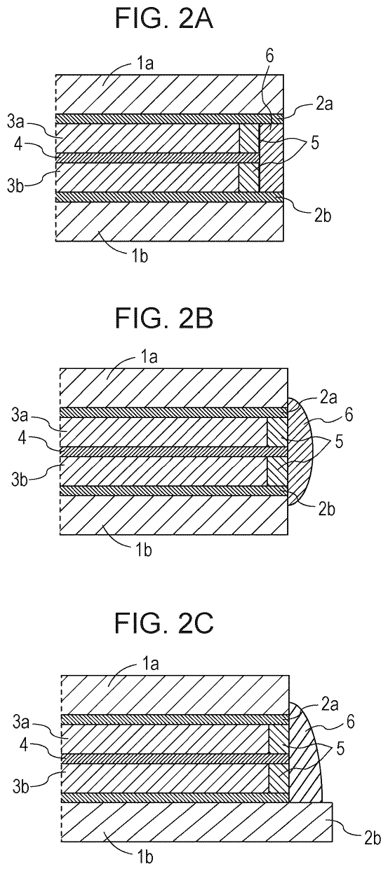

FIGS. 2A to 2C are schematic sectional views of an EC element of the present disclosure taken in the thickness direction, illustrating examples of seal placement. FIG. 2A illustrates an example in which the seal 6 is placed on the inner side on the substrate surface and outside the adhesive 5; FIG. 2B is an example in which the seal 6 is placed on the outside of the substrate surface and outside the adhesive 5, that is, on the side surface of the EC element; and FIG. 2C is an example that takes the same placement as in FIG. 2B, but one of the substrates is extended so that the seal is placed on the surface of the substrate. Any placement can be used as appropriate in consideration of the thickness of the substrates, the required properties of the seal 6, the simplicity of the process, and other factors.

Although the above-described embodiment describes a complementary EC element whose separator 4 is permselective, the concept disclosed herein can be favorably applied to EC elements using a separator having a smaller thermal expansion coefficient than the electrodes without being limited to such a structure.

### Applications of EC Element

The EC element disclosed herein can be used in optical filters, lens units, imaging devices, window components, and the like.

### Optical Filter

An optical filter according to an embodiment includes an EC element and an active element connected to the EC element. The active element drives the EC element and adjusts the amount of light passing through the EC element. The active element may be a transistor, for example. The transistor may contain an oxide semiconductor material, such as InGaZnO, in the active region.

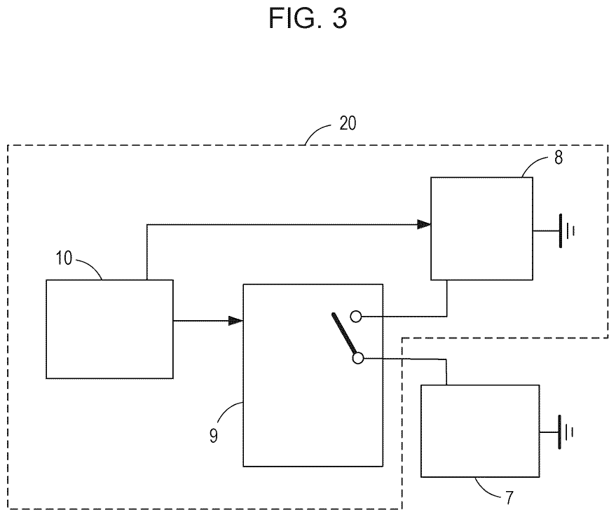

The optical filter according to an embodiment includes the EC element disclosed herein and a drive unit connected to the EC element. FIG. 3 is a schematic diagram illustrating a drive unit 20 for an EC element and an EC element 7 driven by the drive unit 20. In the illustrated embodiment, the drive unit 20 includes a driving power supply 8, a resistor switch 9, and a controller 10.

The driving power supply 8 applies a voltage (driving voltage) required for the electrochemical reaction of the EC materials in the EC layers to the EC element 7. Preferably, the driving voltage is constant. The reason for the application of a constant voltage is that when a plurality of EC materials are used, their absorption spectra may vary due to differences in redox potentials or molar absorption coefficients of the EC materials. The voltage application from the driving power supply 8 is started or maintained in response to a signal from the controller 10. While the light transmittance of the EC element 7 is controlled, the application of a constant voltage is maintained.

The controller 10 controls the transmittance of the EC element 7 in a suitable way for the EC element 7. More specifically, predetermined conditions may be input to the EC element 7 according to a desired transmittance set value, or conditions to meet the transmittance set value may be selected and input according to the comparison between the transmittance set value and the transmittance of the EC element 7. Parameters to be varied include voltage, current, and duty ratio. The controller 10 can vary the voltage, current, or duty ratio to change the color density of the EC element 7.

In the embodiments disclosed herein, known techniques can be used to vary voltage, vary current, and modulate the pulse width. Also, the pulse width may be modulated as described below.

The resistor switch 9 switches between a resistor R1 and a resistor R2 with higher resistance than R1 (both not shown), and connects either resistor in series in a closed circuit including the driving power supply 8 and the EC element 7. The resistance of the resistor R1 may be lower than at least the highest impedance in the closed circuit of the element and is, preferably, 10Ω or less. The resistance of the resistor R2 may be higher than the highest impedance in the closed circuit of the element and is, preferably, 1 MΩ or more. The resistor R2 may be air. In this instance, the closed circuit is open in the strict sense but can be considered closed, provided that air is interpreted as resistor R2.

The controller 10 transmits switching signals to the resistor switch 9 to control the switching between the resistors R1 and R2. Alternatively, the controller 10 may generate PWM signals using a comparator or the like without a resistor switch 9.

### Lens Unit

The lens unit according to an embodiment of the present disclosure includes an imaging optical system including a plurality of lenses, and an optical filter including the EC element disclosed herein. The optical filter may be disposed between the plurality of lenses or outside the lenses. Preferably, the optical filter is disposed on the optical axis of the lenses.

### Imaging Device

The imaging device according to an embodiment of the present disclosure includes an optical filter and a light-receiving element capable of receiving light passing through the optical filter. Specific examples of the imaging device include cameras, video cameras, and camera phones. The imaging device may be such that the main body including the light-receiving element is separable from a lens unit including one or more lenses. In an embodiment in which the main body of the imaging device is separable from a lens unit, an optical filter apart from the imaging device may be used for imaging. Such a structure is also within the scope of the present disclosure. In such an embodiment, the optical filter may be disposed outside the lens unit, between the lens unit and the light-receiving element, or between the lenses (when the lens unit includes a plurality of lenses).

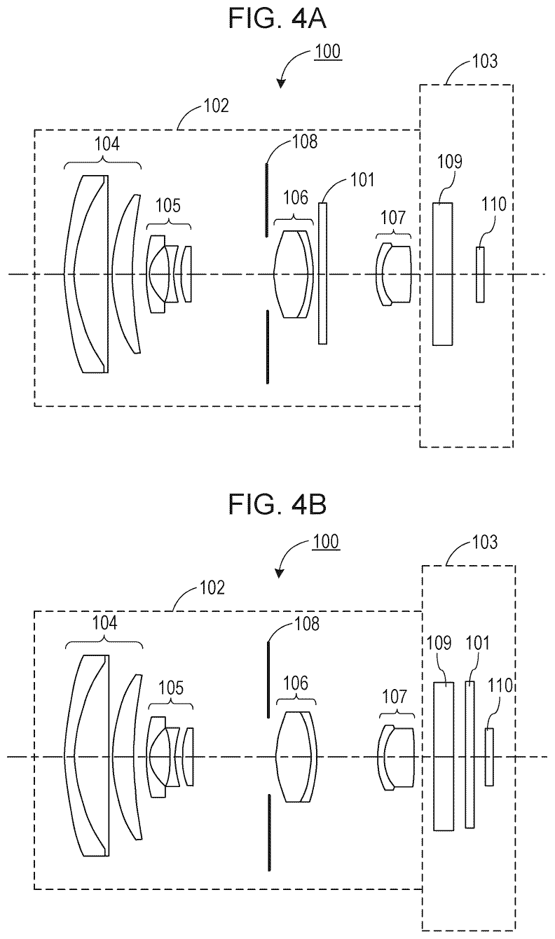

FIG. 4A is a schematic diagram of an example of the imaging device in which the optical filter is disposed in the lens unit, and FIG. 4B is a schematic diagram of an example of the imaging device in which the optical filter is disposed in an imaging unit.

The imaging device 100 includes a lens unit 102 and an imaging unit 103. The lens unit 102 illustrated in FIG. 3A includes an optical filter 101, and an imaging optical system including a plurality of lenses or lens sets. The optical filter 101 is an optical filter according to the above-described embodiment.

The lens unit 102, for example, in FIG. 4A, is a rear focusing zoom lens that focuses behind the diaphragm. The lens unit 102 includes four lens sets arranged in the following order from the object to be imaged: a first lens set 104 having a positive refractive power, a second lens set 105 having a negative refractive power, a third lens set 106 having a positive refractive power, and a fourth lens set 107 having a positive refractive power. The distance between the second lens set 105 and the third lens set 106 is varied to vary magnification, and some of the lenses of the fourth lens set 107 are moved for focusing.

For example, the lens unit 102 includes an aperture diaphragm 108 between the second lens set 105 and the third lens set 106, and the optical filter 101 between the third lens set 106 and the fourth lens set 107. The lens unit 102 is configured so that the light entering the lens unit passes through the lens sets 104 to 107, the diaphragm 108, and the optical filter 101, allowing the aperture diaphragm 108 and the optical filter 101 to adjust the amount of light. The lens unit 102 is removably connected to the imaging unit 103 with a mounting member (not shown).

Although in the present embodiment, the optical filter 101 is disposed between the third lens set 106 and the fourth lens set 107 in the lens unit 102, the imaging device 100 is not limited to this configuration. For example, the optical filter 101 may be disposed in front of the aperture diaphragm 108 (on the imaging subject side), behind the aperture diaphragm (on the imaging unit 103 side), in front of or behind any of the first to fourth lens sets 104 to 107, or between any two of the lens sets. Placing the optical filter 101 at the position where light converges is beneficial, for example, for reducing the area of the optical filter 101.

The configuration of the lens unit 102 is also not limited to that described above and may be selected as appropriate. The lens unit may be of a type other than the rear focusing type and may, for example, be of an inner focusing type that focuses on a position in front of the diaphragm or any other type. Also, the lens unit may be a special lens selected as appropriate, such as a fisheye lens or a microlens, as well as a zoom lens.

The imaging unit 103 includes a glass block 109 and a light-receiving element 110. The glass block 109 may be a low-pass filter, a face plate, or a color filter. The light-receiving element 110 is a sensor that receives light passing through the lens unit and may be an imaging element, such as CCD or CMOS. Alternatively, the light-receiving element 110 may be a light sensor such as a photodiode, and an element or device capable of obtaining and outputting information such as light intensity or wavelength may be used as appropriate.

When the optical filter 101 is incorporated in the lens unit 102, as depicted in FIG. 4A, the drive unit may be placed within or outside the lens unit 102. When placed outside the lens unit 102, the drive unit is connected to the EC element in the lens unit 102 for drive control via a wire.

In the above-described imaging device 100, the optical filter 101 is located inside the lens unit 102. However, the configuration, in the present disclosure, is not limited to that of the above embodiment, provided that the optical filter 101 is located at an appropriate position inside the imaging device 100 so that the light-receiving element 110 can receive the light passing through the optical filter 101.

For example, the imaging unit 103 may have the optical filter 101, as depicted in FIG. 4B. FIG. 4B is a schematic diagram of another embodiment of the imaging device disclosed herein, illustrating a configuration in which the optical filter 101 is located in the imaging unit 103. In FIG. 4B, the optical filter 101 is located, for example, directly in front of the light-receiving element 110. When the imaging device itself incorporates an optical filter 101, the lens unit 102 to be connected need not include the optical filter 101. Accordingly, a dimmable imaging device can be provided using an existing lens unit 102.

The imaging device 100 disclosed herein can be applied to products including a combination of a light-receiving element and the function of adjusting the amount of light. For example, the imaging device may be a camera, a digital camera, a video camera, or a digital video camera, and can also be used in products, such as mobile phones, smartphones, PCs, and tablet computers, which incorporate an imaging device.

According to the imaging device 100 disclosed herein, the optical filter 101 can be used as a dimmer member to enable a single filter to vary the dimming level as appropriate. This is beneficial for reducing the number of components and saving space.

### Window

A window according to an embodiment of the present disclosure includes an EC element and an active element connected to the EC element. The active element drives the EC element and adjusts the amount of light passing through the EC element. The active element may be a transistor, for example. The transistor may contain an oxide semiconductor material, such as InGaZnO, in the active region. The window according to the present embodiment may be called a variable transmittance window.

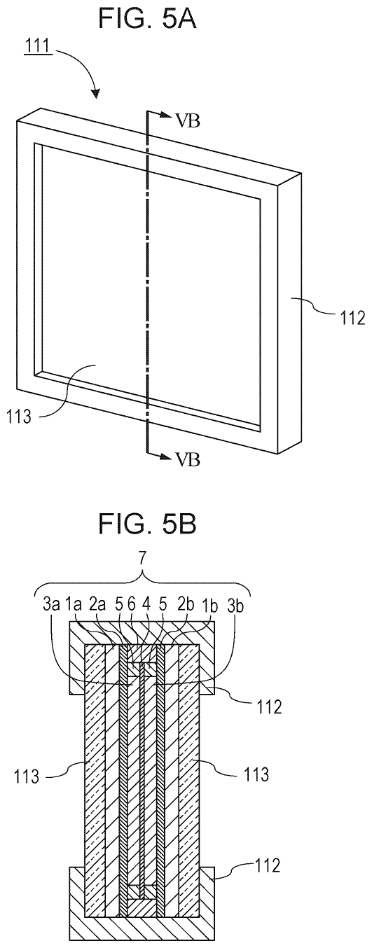

FIG. 5A is a schematic diagram of a dimming window used as a window component including the EC element disclosed herein, and FIG. 5B is a schematic sectional view in the thickness direction taken along line VB-VB at the center of FIG. 5A. The dimming window 111 of the illustrated embodiment includes an EC element (optical filter) 7, transparent plates 113 holding the EC element therebetween, and a frame 112 surrounding and integrating the entire structure. The EC element 7 used in the present embodiment has the structure depicted in FIG. 1 and is provided with a drive unit (not shown). The drive unit may be integrated with a frame 112 or located outside the frame 112 and connected to the EC element 7 with a wire.

The material of the transparent plates 113 is not limited, provided that the material has high light transmittance, and glass is preferably used in view of its use in the window. The frame 112 may be made of any material, and substantially any structure that covers at least a portion of the EC element 7 and has an integrated form can be considered the frame. While in the embodiment illustrated in FIGS. 5A and 5B, the EC element 7 is a component member independent of the transparent plates 113, the substrates 1a and 1b of the EC element 7, for example, may be considered the transparent plates 113.

The dimming window may be used, for example, to adjust the amount of sunlight entering a room during the daytime. The dimming window may also be used to adjust the amount of heat as well as the amount of sunlight, thus used to control the brightness and temperature in a room. Also, the dimming window may be used as a shutter to block views from the outside to the interior. Such a dimming window may be used as a window for vehicles, such as cars, trains, airplanes, and ships, as well as a glass window for buildings.

Thus, the EC element disclosed herein can be used in optical filters, lens units, imaging devices, window components, and other applications.

The EC element may be provided with a reflection member in one of the light paths to function as an electrochromic mirror. The EC mirror may be designed as an anti-glare mirror for vehicles. The EC mirror may include an EC element and a reflection member disposed inside or outside the EC element. Having a reflection member inside the EC element implies that the EC element has a reflective electrode. Having a reflection member outside the EC element implies that the reflection member is disposed in contact with an electrode of the EC element or with another transparent member between the reflection member and the electrode.

### EXAMPLES

### Example 1

An ITO electrode with a sheet resistance of 10 Ω/sq was formed on a non-alkali glass (OA-11, manufactured by Nippon Electric Glass) substrate to prepare an electrode substrate. The electrode substrate and a 20 μm-thick separator made of nanocellulose with fiber diameters of 2 nm to 4 nm, measured by AFM observation, were bonded with a gap of 30 μm therebetween using an adhesive. Adhesives used and their curing conditions are presented below.

### Adhesives and Their Curing Conditions

### Acrylic Adhesives (UV-Curable, One-Component, Solvent-Free)

3035B, produced by ThreeBond: irradiated with UV light with a wavelength of 365 nm at 3000 mJ/cm², and then heated at 80° C. for 30 minutes
8840, produced by Kyoritsu Chemical: irradiated with UV light with a wavelength of 365 nm at 6000 mJ/cm², and then heated at 80° C. for 30 minutes
XVL-90T3, produced by Kyoritsu Chemical: irradiated with UV light with a wavelength of 365 nm at 4500 mJ/cm², and then heated at 80° C. for 30 minutes

### Epoxy Adhesives (Thermosetting)

Torr Seal, produced by Agilent: heated at 60° C. for 30 minutes, and then dried at 60° C. for 120 minutes
Maxive, produced by Mitsubishi Gas Chemical: heated at 80° C. for 30 minutes, and then dried at 80° C. for 120 minutes

### Epoxy Adhesives (UV/Heat Combination-Curable Type)

XMF-DU206B, produced by Mitsui Chemicals: irradiated with UV light with a wavelength of 365 nm at 3000 mJ/cm², and then heated at 80° C. for 30 minutes
E220, produced by Sekisui Chemical: irradiated with UV light with a wavelength of 365 nm at 1500 mJ/cm², and then heated at 80° C. for 30 minutes

### Appearance Evaluation of Separator

The appearance of the separator was evaluated by visual observation, after UV irradiation and after heating for cases using acrylic adhesives or UV/heat combination-curable epoxy adhesives, and after drying for cases using thermosetting epoxy adhesives. Evaluation criteria are as follows. The results are presented in the Table.
Excellent: No sagging
Good: Slightly sagging
Fair: Sagging
Poor: Wrinkling
   Reactivity with EC Layers

Furthermore, the reactivity of the EC solution, prepared by dissolving the anodic EC compound and cathodic EC compound presented below in propylene carbonate, with the EC layers was estimated based on the color change when the EC solution was brought into contact with each adhesive. Evaluation criteria are as follows. The results are presented in the Table.

### Anodic EC Compound: 30 mM

3-(2-isopropoxy-6-methoxyphenyl)-1,5,10-trimethyl-8-phenoxy-5,10-dihydrophenazine

### Cathodic EC Compound: 30 mM

9,9-dimethyl-2,7-bis(4,4,4-trifluorobutyl)-9H-cyclopenta[1,2-c:4,3-c′]dipyridinium bis[bis(trifluoromethanesulfonyl)imide]
   Good: No color change in the EC layers
   Poor: Color changed in the EC layers
      Adhesion of Separator with Electrode Substrate

After curing, the separator was separated from the electrode substrate for a separation test to relatively evaluate the adhesion of the separator with the substrate. Evaluation criteria are as follows. The results are presented in the Table.
Good: Not separated even by the application of a load of 100 gf/cm²
Fair: Separated by the application of a load of 100 gf/cm²

TABLE

| | | | | UV/heat |
|---|---|---|---|---|
| | | | | combination- |
| | | Acrylic | Thermosetting | curable epoxy |
| | | adhesives | epoxy adhesives | adhesives |
| Separator | After UV | Fair-Good | N/A | Fair |
| appearance | irradiation | | | |
| | After heat- | Excellent | Fair | Poor |
| | treatment | | | |

| | | | |
|---|---|---|---|
| Reactivity with EC layers | Good | Poor | Poor |
| Adhesion of separator with electrode | Good | Fair | Fair |
| Substrate | | | |

Epoxy adhesives, irrespective of whether thermosetting or UV/heat combination-curable, exhibited poor adhesion between the separator and the electrode substrate, as well as reactivity with the EC layers. In addition, the separator exhibited sag or wrinkles in appearance after curing or heat treatment, and the epoxy adhesives could not maintain a constant gap between the electrode surface and the separator. In contrast, acrylic adhesives exhibited good adhesion with the separator and did not react with the EC layers. Also, although the separator slightly sagged after UV irradiation, the sagging was eliminated by heat treatment.

### Example 2

Two electrode substrates, identical to the one used in Example 1, were prepared. A UV-curable acrylic adhesive (3035B, produced by ThreeBond) was drawn to a thickness of 30 μm on one of the electrode substrates, using a dispenser. Then, onto this substrate, an EC compound solution prepared by dissolving the anodic compounds and cathodic compounds presented below in propylene carbonate was dropped, and a separator identical to that used in Example 1 was vacuum-bonded. Furthermore, the same adhesive and an epoxy seal (XMF-DU206B, produced by Mitsui Chemicals) to surround the adhesive were drawn to a thickness of 30 μm onto the other of the electrode substrates. Then, onto this electrode substrate, the EC compound solution was dropped, and the other, separator-bonded, electrode substrate was bonded together. Subsequently, the acrylic adhesive and the epoxy seal were cured by irradiation with UV light with a wavelength of 365 nm at 3000 mJ/cm², and subsequent heat treatment at 80° C. for 30 minutes, thus completing an EC element.

### Anodic EC Compounds:

3-(2-isopropoxy-6-methoxyphenyl)-1,5,10-trimethyl-8-phenoxy-5,10-dihydrophenazine (27 mM)
5,10-diisopropyl-2-(3-methoxyphenoxy)-7-methyl-5,10-dihydrophenazine (351 mM)

### Cathodic EC Compounds

9,9-dimethyl-2,7-bis(4,4,4-trifluorobutyl)-9H-cyclopenta[1,2-c:4,3-c′]dipyridinium bis[bis(trifluoromethanesulfonyl)imide] (284 mM)
1,1′-bis(4-tert-butyl)phenyl-3-methyl-4,4′-dipyridinium bis[bis(trifluoromethanesulfonyl)imide] (94 mM)

The resulting EC element was visually observed. The separator exhibited no wrinkles, sags, tears, or separation from the electrode substrate, having a uniform and favorable appearance. When a constant voltage of 0.6 V was applied to the EC element, the light transmittance reached 1% in about 2 minutes. Thus, the EC element exhibited high-quality uniform coloration.

### Example 3

Two ITO-coated PET film substrates with a sheet resistance of 80 Ω/sq were prepared as electrode substrates. A UV-curable acrylic adhesive (XVL-90T3, produced by Kyoritsu Chemical) was drawn to a thickness of 30 μm on one of the electrode substrates, using a dispenser. Then, onto this substrate, the same EC compound solution as used in Example 2 was dropped, and the separator identical to that used in Example 1 was vacuum-bonded. Furthermore, the same acrylic adhesive and an epoxy seal (E220, produced by Sekisui Chemical) to surround the adhesive were also drawn onto the other electrode substrate. Then, onto this substrate, the same EC compound solution was dropped, and the other, separator-bonded, electrode substrate was bonded together. Subsequently, irradiation with UV light with a wavelength of 365 nm at 4500 mJ/cm² and subsequent heat treatment at 80° C. for 30 minutes were performed to complete an EC element.

The resulting EC element was visually observed. The separator exhibited no wrinkles, sags, tears, or separation from the electrode substrate, having a uniform and favorable appearance. When a constant voltage of 0.7 V was applied to the EC element, the light transmittance reached 1% in about 3 minutes. Thus, the EC element exhibited high-quality uniform coloration.

### Comparative Example

Two electrode substrates, identical to the one used in Example 1, were prepared. A UV/heat combination-curable epoxy adhesive (XMF-DU206B, produced by Mitsui Chemicals) was drawn to a thickness of 30 μm on one of the electrode substrates, using a dispenser. Then, onto this substrate, the same EC compound solution as used in Example 2 was dropped, and a 20 μm-thick nanocellulose separator was vacuum-bonded. Furthermore, the same adhesive and an epoxy seal (E220, produced by Sekisui Chemical) to surround the adhesive were also drawn onto the other electrode substrate. Then, onto this substrate, the EC compound solution was dropped, and the other, separator-bonded, electrode substrate was bonded together. Subsequently, irradiation with UV light with a wavelength of 365 nm at 3000 mJ/cm² and subsequent heat treatment at 80° C. for 30 minutes were performed to complete an EC element.

When the resulting EC element was visually observed, the rectangular separator was wrinkled at corners and exhibited coloration even in the electrically neutral state. When a constant voltage of 0.6 V was applied to this EC element, the transmittance decreased to only about 20%, and nonuniform coloration was observed.

The present disclosure provides an EC element with high display quality that includes a separator separating EC layers without wrinkles or sagging, and that, even in a complementary type, achieves both excellent transparency and low power consumption in the electrically neutral state.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. An electrochromic element comprising:
a first electrode;
a second electrode;
a separator that divides a gap between the first electrode and the second electrode into two sections;
a first electrochromic layer disposed between the first electrode and the separator and containing at least one electrochromic compound; and
a second electrochromic layer disposed between the second electrode and the separator and containing at least one electrochromic compound,
wherein the separator has a smaller thermal expansion coefficient than the first and second electrodes, and each of the first electrode and the second electrode is bonded to the separator with an acrylic adhesive.

2. The electrochromic element according to claim 1, wherein the first electrochromic layer contains at least one cathodic electrochromic compound, and the second electrochromic layer contains at least one anodic electrochromic compound.

3. The electrochromic element according to claim 1, wherein the separator is made of nanofibers.

4. The electrochromic element according to claim 3, wherein the nanofibers are made of nanocellulose.

5. The electrochromic element according to claim 4, wherein the separator has an average fiber diameter of 10 nm or less.

6. The electrochromic element according to claim 1, wherein the acrylic adhesive is a UV-curable adhesive.

7. An optical filter comprising:
the electrochromic element according to claim 1; and
a transistor connected to the electrochromic element.

8. A lens unit comprising:
the optical filter according to claim 7; and
an imaging optical system including a plurality of lenses.

9. An imaging device comprising:
the optical filter according to claim 7; and
a light-receiving element configured to receive light passing through the optical filter.

10. A window component comprising:
the electrochromic element according to claim 1; and
a transistor connected to the electrochromic element.

11. An electrochromic mirror comprising:
the electrochromic element according to claim 1; and
a reflection member disposed inside or outside the electrochromic element.

12. A method for manufacturing an electrochromic element including a first electrode, a second electrode, a separator that divides a gap between the first electrode and the second electrode into two sections, a first electrochromic layer disposed between the first electrode and the separator and containing at least one electrochromic compound, and a second electrochromic layer disposed between the second electrode and the separator and containing at least one electrochromic compound, the method comprising:
bonding each of the first electrode and the second electrode to the separator with an acrylic adhesive, curing the acrylic adhesive, and then heat-treating the acrylic adhesive.
